(19) United States
(12) Patent Application Publication
(10) Pub. No.: US 2018/0027464 A1
(43) Pub. Date: Jan. 25, 2018

(54) WIRELESS COMMUNICATION DEVICE, WIRELESS COMMUNICATION METHOD, WIRELESS COMMUNICATION TERMINAL, AND PROGRAM

(71) Applicant: SEIKO EPSON CORPORATION, Tokyo (JP)

(72) Inventor: Daiki YOKOYAMA, Azumino-shi (JP)

(21) Appl. No.: 15/620,205

(22) Filed: Jun. 12, 2017

(30) Foreign Application Priority Data
Jul. 21, 2016 (JP) 2016-143105

(51) Int. Cl. H04W 36/14; H04W 36/00

(52) U.S. Cl. CPC H04W 36/14; H04W 36/0016

(57) ABSTRACT

A wireless communication device determines the optimal handover destination based on data related to the communicated object. A wireless communication device has a first wireless communicator 34a that communicates by a first wireless communication method; a second wireless communicator 34b that communicates by a second wireless communication method having a slower communication speed than the first wireless communication method; and a first controller 32 configured to control the first wireless communicator 34a and second wireless communicator 34b. The second wireless communicator 34b receives data related to the communicated object from a wireless communication terminal 20. Based on the data related to the communicated object received by the second wireless communicator 34b, the first controller 32 determines whether to use the first wireless communication method or the second wireless communication method as the wireless communication method for receiving the specific data that is the communicated object.

### CROSS-REFERENCE TO RELATED APPLICATIONS

The entire disclosure of Japanese Patent Application No.2016-143105, filed Jul. 21, 2016 is expressly incorporated by reference herein.

### BACKGROUND

### 1. Technical Field

The present invention relates to a wireless communication device, wireless communication method, wireless communication terminal, and program.

### 2. Related Art

Communication systems that include a first wireless communicator (such as a Bluetooth(R) communicator) and a second wireless communicator (such as a NFC communicator), communicate first through the second wireless communicator, and then hand off communication by the second wireless communicator to communication by the first wireless communicator, are known from the literature. See, for example, JP-A-2010-134610 and JP-A-2009-135865.

A problem with the technology described in the cited references is that, even when the data size of the specific data being communicated is large, communication may be handed off to a wireless communication mode with a slow communication speed (such as BlueTooth Low Energy), and much time may be required to transmit the specific data.

### SUMMARY

The present invention is directed to the foregoing problem, and an objective of the invention is to provide a wireless communication device that determines the optimal handover destination based on the data to be communicated (such as the data size of the specific data).

To achieve the foregoing objective, one aspect of the invention is a wireless communication device including: a first wireless communicator configured to communicate by a first wireless communication method; a second wireless communicator configured to communicate by a second wireless communication method having a slower communication speed than the first wireless communication method; and a first controller configured to control the first wireless communicator and second wireless communicator. The second wireless communicator receives data related to the communicated object from the corresponding wireless communication terminal. The first controller, based on data related to the communication object received through the second wireless communicator, determines whether to use the first wireless communication method or the second wireless communication method as the wireless communication method for receiving the specific data to be communicated.

This aspect of the invention provides a wireless communication device that can determine the optimal handover destination based on data related to the data to be transmitted (such as the data size of the specific data).

Preferably in another aspect of the invention, the data related to the communicated object indicates the data size of the specific data.

This aspect of the invention provides a wireless communication device that can determine the optimal handover destination based on the data size of the specific data.

Preferably in another aspect of the invention, the first controller calculates, from the data size of the specific data, the communication time required for communication, and based on the calculated communication time, determines whether to use the first wireless communication method or the second wireless communication method as the wireless communication method to receive the specific data of the communicated object.

This aspect of the invention can determine the optimal handover destination based on the calculated communication time.

Preferably in another aspect of the invention, the wireless communication also has a comparator configured to compare the time required to receive the specific data by the second wireless communicator, with the sum of the time required to change from the second wireless communicator to the first wireless communicator plus the time required to receive the specific data by the first wireless communicator; the first controller determining, based on the result from the comparator, whether to use the first wireless communication method or the second wireless communication method as the wireless communication method to receive the specific data of the communicated object.

This aspect of the invention can determine the optimal handover destination based on the result from the comparator.

Preferably in another aspect of the invention, the data related to the communicated object indicates the data type of the specific data.

This aspect of the invention provides a wireless communication device that can determine the optimal handover destination based on the data type of the specific data.

Preferably in another aspect of the invention, when the first controller selects the first wireless communication method to receive the specific data, the second wireless communicator sends to the corresponding wireless communication terminal, by the second wireless communication method, connection information for connecting to an access point by the first wireless communication method.

Preferably in another aspect of the invention, the second wireless communication method is communication by the BlueTooth Low Energy standard.

Preferably in another aspect of the invention, the specific data is print data.

Another aspect of the invention is a wireless communication method of a wireless communication device including a first wireless communicator configured to communicate by a first wireless communication method, a second wireless communicator configured to communicate by a second wireless communication method having a slower communication speed than the first wireless communication method, and a first controller configured to control the first wireless communicator and second wireless communicator; the wireless communication method including a reception step of the second wireless communicator receiving data related to the communicated object from a corresponding wireless communication terminal; and a wireless communication method determination step of the first controller, based on data related to the communication object received by the second wireless communicator, determining whether to use the first wireless communication method or the second wireless communication method as the wireless communication method to receive the specific data that is the communicated object.

This aspect of the invention provides a wireless communication method that, based on data related to the data to be transmitted (such as the data size of the specific data), can determine the optimal handover destination.

To achieve the foregoing objective, another aspect of the invention is a wireless communication terminal that communicates with a wireless communication device, and the wireless communication terminal including: a third wireless communicator configured to communicate by a first wireless communication method; a fourth wireless communicator configured to communicate by a second wireless communication method having a slower communication speed than the first wireless communication method; and a second controller configured to control the third wireless communicator and fourth wireless communicator. The second controller, based on data related to a communication object transmitted by the fourth wireless communicator, determines whether to use the first wireless communication method or the second wireless communication method to send the specific data that is the communicated object.

This aspect of the invention provides a wireless communication terminal that, based on data related to the data to be transmitted (such as the data size of the specific data), can determine the optimal handover destination.

To achieve the foregoing objective, another aspect of the invention is a computer-readable non-transitory recording medium storing a program causing a wireless communication terminal that communicates with a wireless communication device and has a third wireless communicator configured to communicate by a first wireless communication method, a fourth wireless communicator configured to communicate by a second wireless communication method having a slower communication speed than the first wireless communication method, and a second controller configured to control the third wireless communicator and fourth wireless communicator, to function as: a wireless communication decision unit that, based on data related to a communication object transmitted by the fourth wireless communicator, determines whether to use the first wireless communication method or the second wireless communication method to send the specific data that is the communicated object.

This aspect of the invention provides a program that, based on data related to the data to be transmitted (such as the data size of the specific data), can determine the optimal handover destination.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 illustrates the configuration of a wireless communication system 10 using a wireless communication device, wireless communication method, wireless communication terminal, and program according to the invention.

FIG. 2 is a sequence diagram used for printing by Bluetooth low energy (BLE) communication.

FIG. 3 is a sequence diagram used for printing by WiFi.

FIG. 4 is a flow chart illustrating a process determining the handover destination.

FIG. 5 is a flow chart illustrating a first variation of the handover destination determination process.

FIG. 6 is a flow chart illustrating a second variation of the handover destination determination process.

FIG. 7 is a flow chart illustrating a third variation of the handover destination determination process.

FIG. 8 is a flow chart illustrating a fourth variation of the handover destination determination process.

### DESCRIPTION OF EMBODIMENTS

Preferred embodiments of the present invention are described below with reference to the accompanying figures. Note that like parts in the accompanying figures are identified by the same reference numerals, and redundant description thereof is omitted.

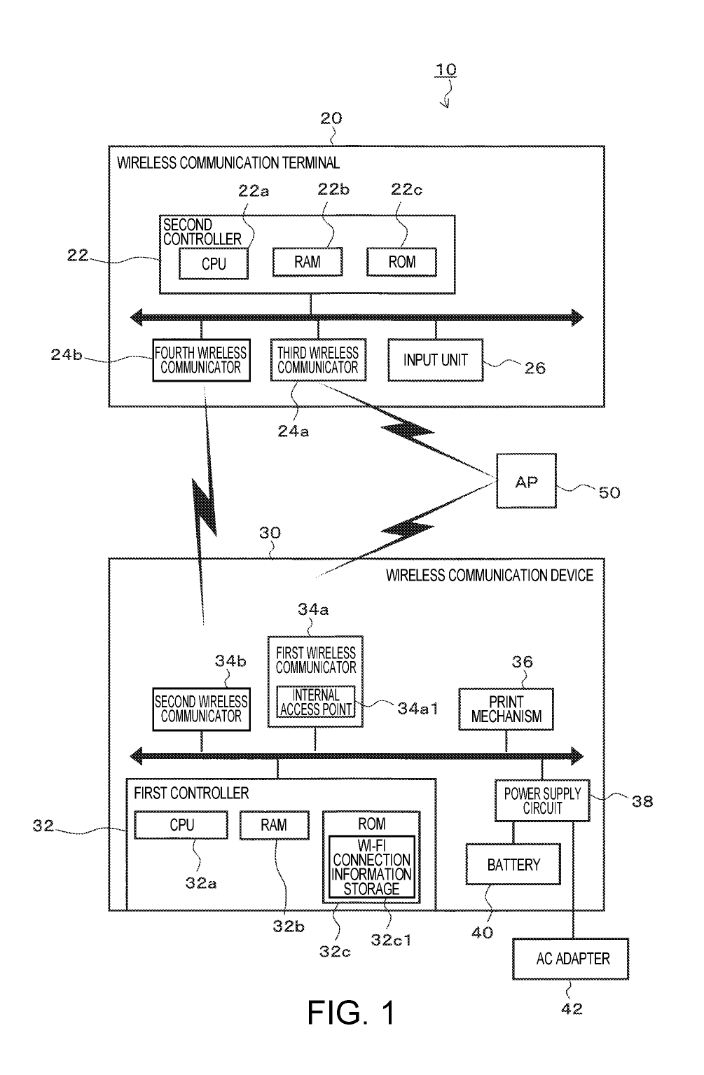

FIG. 1 illustrates the configuration of a wireless communication system 10 using a wireless communication device, wireless communication method, wireless communication terminal, and program according to the invention.

As shown in FIG. 1, the wireless communication system 10 according to this embodiment includes a wireless communication device 30, wireless communication terminal 20, and relay device 50.

The wireless communication device 30 in this example is typically a printer, but the invention is not so limited and may be a scanner, photocopier, fax machine, or a multifunction device including at least two of these functions. When connected to an AC adapter 42, the wireless communication device 30 operates with power supplied from the AC adapter 42. When not connected to an AC adapter 42, the wireless communication device 30 operates with power supplied from a battery 40.

The hardware configuration of the wireless communication device 30 includes a first controller 32, a first wireless communicator 34a, a second wireless communicator 34b, a print mechanism 36, a power supply circuit 38, and a battery 40.

The first controller 32 includes a CPU 32a, RAM 32b, and ROM 32c.

RAM 32b is used as working memory by the CPU 32a to execute processes.

ROM 32c is flash ROM or other rewritable nonvolatile memory, and stores firmware such as a control program. ROM 32c also includes Wi-Fi connection information storage 32c1.

The Wi-Fi connection information stored in Wi-Fi connection information storage 32c1 is connection information for connected to an access point by Wi-Fi communication, and includes the SSID and password for connecting to the access point, and the IP address of the destination wireless communication device 30 when sending print data by Wi-Fi communication to the wireless communication device 30. The access point may be a relay device 50 (external access point) or an internal access point 34a1 (internal AP).

Note that the first controller 32 and the second controller 22 described below may be configured from one or more hardware devices such as CPUs or ASIC (Application Specific Integrated Circuit) devices, or plural devices may work together as a processor that executes specific processes.

The first controller 32 controls the first wireless communicator 34a and second wireless communicator 34b. The first controller 32, based on data related to the data received by the second wireless communicator 34b (such as the data size of the print data or the number of pages to print), determines whether to use Wi-Fi communication or BLE communication to receive the specific data being communicated (such as print data).

The first wireless communicator 34a is a communication interface for communication by a first wireless communication method. The first wireless communication method in this example is wireless communication by Wi-Fi (referred to below as Wi-Fi communication). The first wireless communicator 34a is configured, for example, by a wireless LAN chip (such as a controller) or a wireless LAN module.

The first wireless communicator 34a also has an internal access point 34a1 (internal access point) enabling a direct connection to a third wireless communicator 24a of the wireless communication terminal 20. An example of the internal access point 34a1 is described in JP-A-2016-86384, for example.

The second wireless communicator 34b is a communication interface for communication by a second wireless communication method with a slower communication speed than the first wireless communication method. In this example, the second wireless communication method is wireless communication by BLE (Bluetooth Low Energy) (referred to below as BLE communication). The second wireless communicator 34b is configured with a BLE chip (such as a controller) or BLE module, for example.

The print mechanism 36 is not shown in the figures, but includes a printhead and paper conveyance mechanism, for example.

The power supply circuit 38 supplies operating voltage for components of the wireless communication device 30, including the first wireless communicator 34a and second wireless communicator 34b. The power supply circuit 38 supplies power from the AC adapter 42 or battery 40 to other parts of the wireless communication device 30. For example, the power supply circuit 38, when both the AC adapter 42 and battery 40 are connected, supplies power from the AC adapter 42 to other parts of the wireless communication device 30. When the AC adapter 42 is not connected and only the battery 40 is connected, the power supply circuit 38 supplies power from the battery 40 to other parts of the wireless communication device 30. The power supply circuit 38 also charges the battery 40.

The battery 40 in this example is a storage battery such as a rechargeable lithium ion battery.

The wireless communication terminal 20 in this example is typically a smartphone, but the invention is not so limited and may be a personal computer (PC), tablet device, or cell phone, for example.

The wireless communication terminal 20 includes a second controller 22, third wireless communicator 24a, fourth wireless communicator 24b, and input unit 26.

The second controller 22 includes a CPU 22a, RAM 22b, ROM 22c.

RAM 22bis used as working memory by the CPU 22a to execute processes.

ROM 22c is flash ROM or other rewritable nonvolatile memory, and stores an operating system (OS) and application program that runs on the OS.

The second controller 22 controls the third wireless communicator 24a and fourth wireless communicator 24b.

The third wireless communicator 24a communicates by Wi-Fi communication (first wireless communication method). The third wireless communicator 24a is configured, for example, by a wireless LAN chip (such as a controller) or a wireless LAN module.

The fourth wireless communicator 24b communicates by BLE communication (second wireless communication method). The fourth wireless communicator 24b is configured with a BLE chip (such as a controller) or BLE module, for example.

The input unit 26 in this example is a touch screen display (a display with a touch panel). A touch screen display functions as both an input device and display unit.

The relay device 50 (external access point) in this example is a router. The relay device 50 may be a device such as described in JP-A-2016-86384.

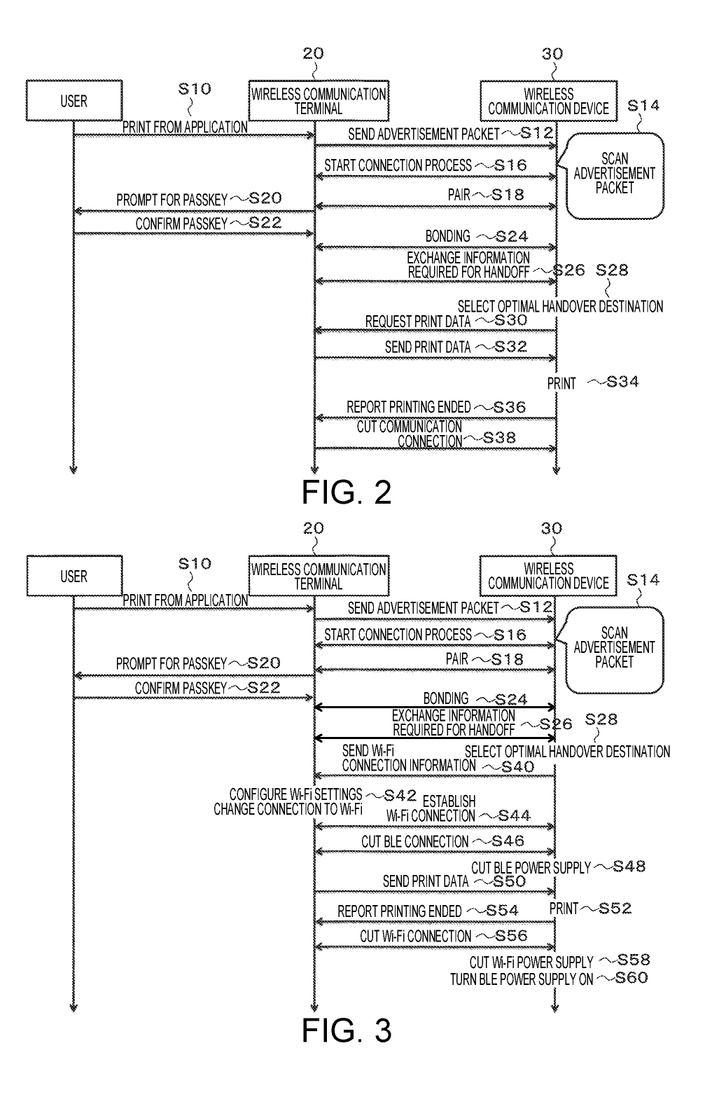

An example of the operation of the wireless communication system 10 according to this embodiment is described next with reference to FIG. 2.

FIG. 2 is a sequence diagram of the operation used for printing by BLE communication.

The process of the wireless communication device 30 described below is enabled by the CPU 32a executing firmware stored in ROM 32c, and the process of the wireless communication terminal 20 is enabled by the CPU 22a executing an application stored in ROM 22c.

First, the user starts the application on the wireless communication terminal 20, and initiates printing from the application program (step S10).

When printing from the application program, the wireless communication terminal 20 becomes the peripheral (slave) device and sends a connectable advertisement packet (step S12).

Next, the wireless communication device 30, as the central (master) device, scans the connectable advertisement packet (step S14), and starts the connection process with the wireless communication terminal 20 (step S16).

Next, pairing is necessary to establish a connection between the wireless communication terminal 20 and wireless communication device 30 (step S18). In this event, the wireless communication terminal 20 prompts the user for passkey entry (step S20), and the user checks the passkey (step S22).

The devices then bond to generate and exchange persistent security encryption keys (step S24).

A connection between the wireless communication terminal 20 and wireless communication device 30 is established through steps S10 to S24. More specifically, BLE communication between the wireless communication terminal 20 and wireless communication device 30 is enabled.

Information required for a handover is then exchanged (step S26). For example, the wireless communication terminal 20, through the fourth wireless communicator 24b, sends to the wireless communication device 30 information related to the transmitted data (such as the data size of the print data and the number of pages).

The wireless communication device 30 receives and stores to RAM 32b, for example, the data related to the transmitted data (such as the data size of the print data and the number of pages) sent from the wireless communication terminal 20 through the second wireless communicator 34b.

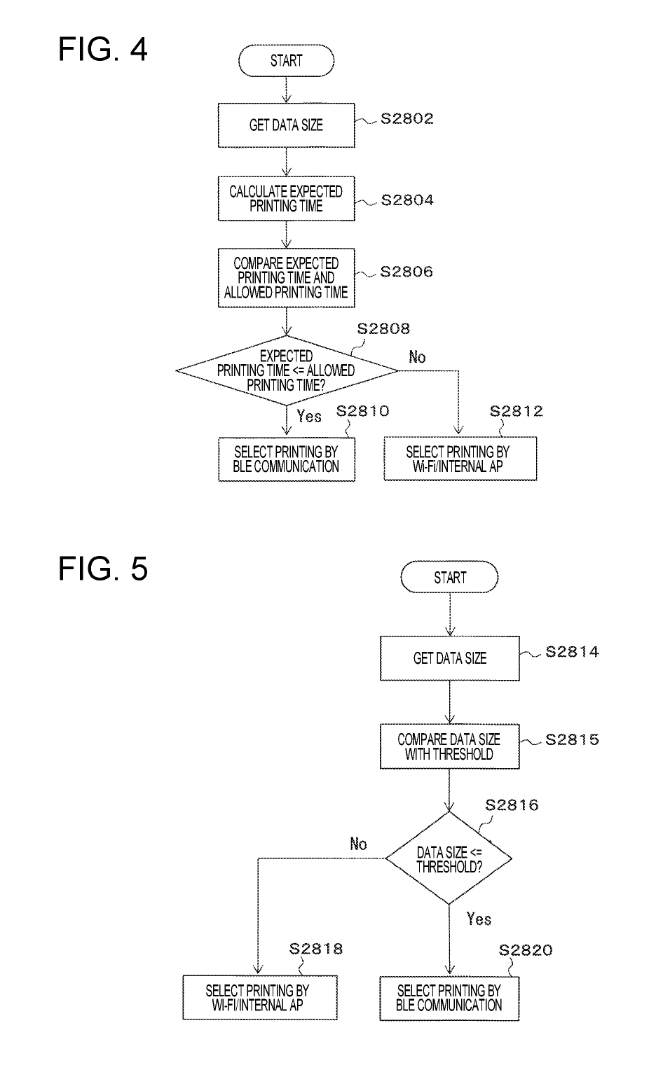

Next, the wireless communication device 30 executes the handover destination determination process (see FIG. 4) based on the information exchanged in step S26, that is, the data related to the transmitted data (such as the data size of the print data and the number of pages) (step S28). The handover destination determination process is described in detail below, and in this example the result of the handover destination determination process is that BLE communication is identified as the optimal handover destination.

Next, the wireless communication device 30 uses BLE communication to request print data from the wireless communication terminal 20 (step S30). More specifically, the wireless communication device 30 requests print data from the wireless communication terminal 20 through the second wireless communicator 34b, which is used for BLE communication (step S30).

Next, the wireless communication terminal 20 that received the print data request sends the print data through the fourth wireless communicator 24b, which handles BLE communication, to the wireless communication device 30 (step S32).

Next, the wireless communication device 30 receives the print data by BLE communication through the second wireless communicator 34b, and based on the received print data, controls the print mechanism 36 to print (step S34).

Next, when printing ends, the wireless communication device 30 reports to the wireless communication terminal 20 by BLE communication through the second wireless communicator 34b that printing ended (step S36).

Next, upon receiving the printing completed report, the wireless communication terminal 20 terminates the BLE communication connection (step S38).

Thereafter, the wireless communication device 30 waits until an advertisement packet sent from the wireless communication terminal 20 is received again.

When the wireless communication device 30 receives the advertisement packet, the process of steps S16 to S38 repeats.

Next, an example of the operation of the wireless communication system 10 according to this embodiment is described with reference to FIG. 3.

FIG. 3 is a sequence diagram of the operation used for printing by Wi-Fi communication.

Below, steps that are the same as in FIG. 2 are identified by the same step numbers.

First, the user starts the application on the wireless communication terminal 20, and initiates printing from the application program (step S10).

When printing from the application program, the wireless communication terminal 20 becomes the peripheral (slave) device and sends a connectable advertisement packet (step S12).

Next, the wireless communication device 30, as the central (master) device, scans the connectable advertisement packet (step S14), and starts the connection process with the wireless communication terminal 20 (step S16).

Next, pairing is necessary to establish a connection between the wireless communication terminal 20 and wireless communication device 30 (step S18). In this event, the wireless communication terminal 20 prompts the user for passkey entry (step S20), and the user confirms the passkey (step S22).

The devices then bond to generate and exchange persistent security encryption keys (step S24).

A connection between the wireless communication terminal 20 and wireless communication device 30 is established through steps S10 to S24. More specifically, BLE communication between the wireless communication terminal 20 and wireless communication device 30 is enabled.

Information required for a handover is then exchanged (step S26). For example, the wireless communication terminal 20, through the fourth wireless communicator 24b, sends to the wireless communication device 30 information related to the transmitted data (such as the data size of the print data and the number of pages).

The wireless communication device 30 receives and stores to RAM 32b, for example, the data related to the transmitted data (such as the data size of the print data and the number of pages) sent from the wireless communication terminal 20 through the second wireless communicator 34b.

Next, the wireless communication device 30 executes the handover destination determination process (see FIG. 4) based on the information exchanged in step S26, that is, the data related to the transmitted data (such as the data size of the print data and the number of pages) (step S28). The handover destination determination process is described in detail below, and in this example the result of the handover destination determination process is that Wi-Fi communication is identified as the optimal handover destination.

Next, the wireless communication device 30 uses BLE communication to acquire the Wi-Fi connection information (step S40). More specifically, the wireless communication device 30 (second wireless communicator 34b) sends connection information for connecting to the relay device 50 (or connection information for connected to the internal access point 34a1) as the Wi-Fi connection information to the communicating wireless communication terminal 20 by BLE communication.

Next, when the Wi-Fi connection information is received, the wireless communication terminal 20 configures the Wi-Fi connection settings (step S42) based on the Wi-Fi connection information, and changes the connection means from the fourth wireless communicator 24b to the third wireless communicator 24a. Likewise, the wireless communication device 30 also changes the connection means from the second wireless communicator 34b to the first wireless communicator 34a. As a result, a Wi-Fi connection is established (step S44). More specifically, the wireless communication terminal 20 and wireless communication device 30 are able to communicate by Wi-Fi.

Next, after sensing that the connection means changed, the wireless communication device 30 ends the BLE communication connection with the wireless communication terminal 20 (step S46), and turns the BLE power supply off (step S48). More specifically, the wireless communication device 30 stops the power supply to the second wireless communicator 34b used for BLE communication.

Power is thus saved by stopping the power supply to the second wireless communicator 34b.

Next, the wireless communication terminal 20 sends print data to the wireless communication device 30 through the third wireless communicator 24a handling Wi-Fi communication (step S50).

Next, the wireless communication device 30 receives the print data sent from the wireless communication terminal 20 through the first wireless communicator 34a by Wi-Fi communication, and based on the received print data, controls the print mechanism 36 to print (step S52).

Next, when printing ends, the wireless communication device 30 reports to the wireless communication terminal 20 by Wi-Fi communication through the first wireless communicator 34a that printing ended (step S54).

Next, upon receiving the printing completed report, the wireless communication terminal 20 terminates the Wi-Fi communication connection (step S56).

Next, the wireless communication device 30 (power supply circuit 38) turns the Wi-Fi power supply off (step S58). More specifically, the wireless communication device 30 (power supply circuit 38) stops the power supply to the first wireless communicator 34a handling Wi-Fi communication.

Power is thus saved by stopping the power supply to the first wireless communicator 34a.

Next, the wireless communication device 30 (power supply circuit 38) turns the BLE power supply on (step S60). More specifically, the wireless communication device 30 (power supply circuit 38) starts supplying power to the second wireless communicator 34b that handles BLE communication.

Thereafter, the wireless communication device 30 waits until an advertisement packet sent from the wireless communication terminal 20 is received again.

When the wireless communication device 30 receives the advertisement packet, the process described above repeats.

Next, an example of the handover destination determination process is described with reference to FIG. 4.

FIG. 4 is a flow chart describing an example of the handover destination determination process.

The handover destination determination process shown in FIG. 4 is a process in which the wireless communication device 30 (first controller 32), based on data related to the data received by the second wireless communicator 34b (in this example, the data size of the print data or the number of pages to print), determines whether to use Wi-Fi communication or BLE communication as the wireless communication method (that is, the optimal handover destination) for receiving the specific data being communicated (in this example, print data). The handover destination determination process shown in FIG. 4 is executed in step S28 in FIG. 2 and FIG. 3.

First, the wireless communication device 30 (second wireless communicator 34b) acquires the data size of the print data and the number of pages from the wireless communication terminal 20 through the fourth wireless communicator 24b (step S2802). This is an example of the reception step in the invention. Note that if the data size of the print data and the number of pages was already acquired in step S26 and stored in RAM 32b, the data size of the print data and the number of pages is acquired from RAM 32b. In this event, this step S2802 is omitted.

Next, the wireless communication device 30 (first controller 32) calculates the expected printing time from equation 1 below (step S2804).

Expected printing time/page (S)=data size (MB)÷number of pages÷data throughput (MB/S) (1)

However, the data size and the number of pages are the data size and number of pages acquired in step S2802. The data throughput is the data throughput including communication overhead. Note that the data throughput may be a previously calculated value stored in ROM 32c, or determined ad hoc.

Next, the wireless communication device 30 (first controller 32) compares the expected printing time calculated in step S2804 with an allowed printing time (step S2806), and determines if the expected printing time is within the allowed printing time (step S2808). This is an example of the wireless communication method determination step in the invention. Note that the allowed printing time is the printing time allowed per page. Note that the allowed printing time is stored in ROM 32c as a predetermined constant (or a value set by the user), and the value read from ROM 32c is used.

If the expected printing time is within the allowed printing time (step S2808: Yes), the wireless communication device 30 (first controller 32) determines to use BLE communication as the wireless communication method (that is, the optimal handover destination) for receiving the specific data being communicated (print data in this example) (step S2810).

However, if the expected printing time is not within the allowed printing time (step S2808: No), the wireless communication device 30 (first controller 32) determines to use Wi-Fi communication (communication by Wi-Fi or the internal AP) as the wireless communication method (that is, the optimal handover destination) for receiving the specific data being communicated (print data in this example) (step S2812).

As described above, this embodiment of the invention provides a wireless communication device capable of determining the optimal handover destination based on data related to the data to be communicated (such as the data size of the print data and the number of pages).

A variation of the decision method is described next.

An example of the handover destination determination process of the invention is described above with reference to FIG. 4, but the invention is not limited to the foregoing handover destination determination process.

FIG. 5 is a flow chart of a handover destination determination process according to a first variation of the foregoing embodiment.

The handover destination determination process shown in FIG. 5 is a process of the wireless communication device 30 (first controller 32), based on data related to the data received by the second wireless communicator 34b (in this example, the data size of the print data), determining whether to use Wi-Fi communication or BLE communication as the wireless communication method (that is, the optimal handover destination) for receiving the specific data being communicated (in this example, print data). The handover destination determination process shown in FIG. 5 is executed in step S28 in FIG. 2 and FIG. 3.

First, the wireless communication device 30 (second wireless communicator 34b) acquires the data size of the print data from the wireless communication terminal 20 through the fourth wireless communicator 24b (step S2814).

Next, the wireless communication device 30 (first controller 32) compares the data size of the print data acquired in step S2814 with a threshold (step S2815), and determines if the data size of the print data is less than or equal to the threshold (step S2816). Note that the threshold is stored in ROM 32c as a predetermined constant (or a value set by the user), and the value read from ROM 32c is used.

If the data size of the print data is less than or equal to the threshold (step S2816: Yes), the wireless communication device 30 (first controller 32) determines to use BLE communication as the wireless communication method (that is, the optimal handover destination) for receiving the specific data being communicated (print data in this example) (step S2820).

However, if the data size of the print data exceeds the threshold (step S2816: No), the wireless communication device 30 (first controller 32) determines to use Wi-Fi communication (communication by Wi-Fi or the internal AP) as the wireless communication method (that is, the optimal handover destination) for receiving the specific data being communicated (print data in this example) (step S2818).

As described above, this embodiment of the invention provides a wireless communication device capable of determining the optimal handover destination based on data related to the data to be communicated (such as the data size of the print data).

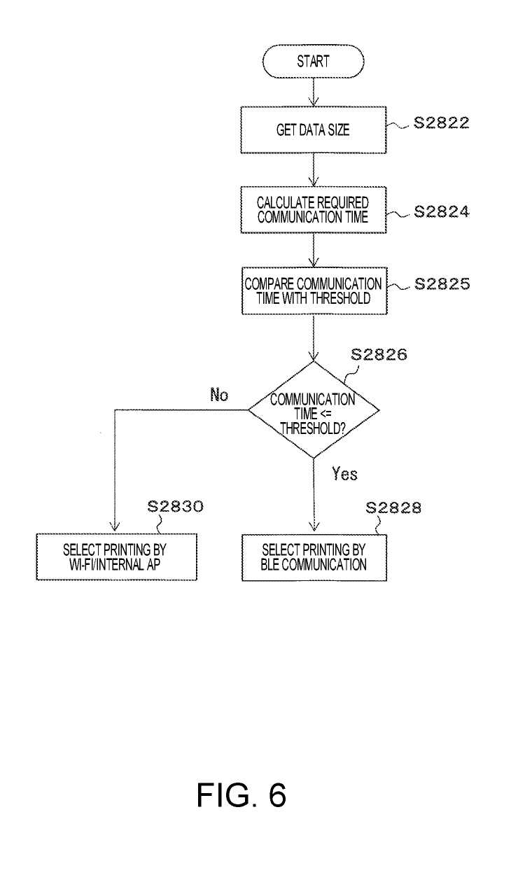

A second variation of the handover destination determination process according to the invention is described next with reference to FIG. 6.

FIG. 6 is a flow chart of a handover destination determination process according to a second variation of the foregoing embodiment.

The handover destination determination process shown in FIG. 6 is a process of the wireless communication device 30 (first controller 32), based on data related to the data received by the second wireless communicator 34b (in this example, the data size of the print data), determining whether to use Wi-Fi communication or BLE communication as the wireless communication method (that is, the optimal handover destination) for receiving the specific data being communicated (in this example, print data). The handover destination determination process shown in FIG. 6 is executed in step S28 in FIG. 2 and FIG. 3.

First, the wireless communication device 30 (second wireless communicator 34b) acquires the data size of the print data from the wireless communication terminal 20 through the fourth wireless communicator 24b (step S2822).

Next, the wireless communication device 30 (first controller 32) calculates the communication time required for communication from equation 2 below (step S2824).

Required communication time (S)=data size (MB)÷data throughput (MB/S) (2)

However, the data size is the data size acquired in step S2822. The data throughput is the data throughput including communication overhead. Note that the data throughput may be a previously calculated value stored in ROM 32c, or determined ad hoc.

Next, the wireless communication device 30 (first controller 32) compares the communication time calculated in step S2824 with a threshold (step S2825), and determines if the communication time is less than or equal to the threshold (step S2826). Note that the threshold is stored in ROM 32c as a predetermined constant (or a value set by the user), and the value read from ROM 32c is used.

If the communication time is less than or equal to the threshold (step S2826: Yes), the wireless communication device 30 determines to use BLE communication as the wireless communication method (that is, the optimal handover destination) for receiving the specific data being communicated (print data in this example) (step S2828).

However, if the communication time exceeds the threshold (step S2826: No), the wireless communication device 30 (first controller 32) determines to use Wi-Fi communication (communication by Wi-Fi or the internal AP) as the wireless communication method (that is, the optimal handover destination) for receiving the specific data being communicated (print data in this example) (step S2830).

This embodiment of the invention provides a wireless communication device capable of determining the optimal handover destination based on data related to the data to be communicated (such as the data size of the print data, more specifically, based on the communication time calculated in step S2824).

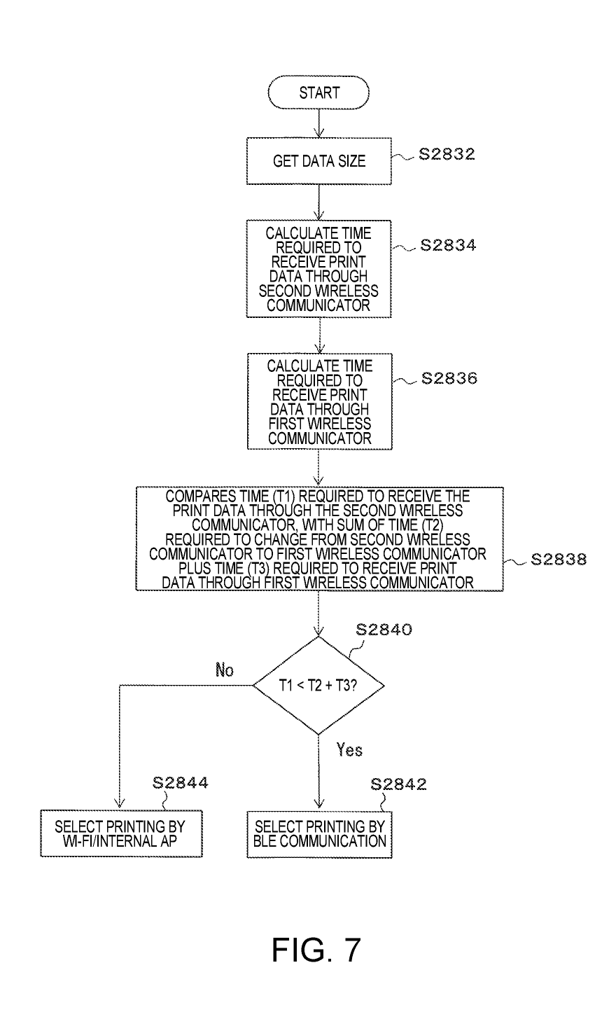

A third variation of the handover destination determination process is described next with reference to FIG. 7.

FIG. 7 is a flow chart of a handover destination determination process according to this third variation of the foregoing embodiment.

The handover destination determination process shown in FIG. 7 is a process of the wireless communication device 30 (first controller 32), based on data related to the data received by the second wireless communicator 34b (in this example, the data size of the print data), determining whether to use Wi-Fi communication or BLE communication as the wireless communication method (that is, the optimal handover destination) for receiving the specific data being communicated (in this example, print data). The handover destination determination process shown in FIG. 7 is executed in step S28 in FIG. 2 and FIG. 3.

First, the wireless communication device 30 (second wireless communicator 34b) acquires the data size of the print data from the wireless communication terminal 20 through the fourth wireless communicator 24b (step S2832).

Next, the wireless communication device 30 (first controller 32) calculates the time required to receive the print data through the second wireless communicator 34b, and the time required to receive the print data through the first wireless communicator 34a (step S2834, S2836).

Next, the wireless communication device 30 (first controller 32) compares the time (T1) required to receive the print data through the second wireless communicator 34b, with the sum of the time (T2) required to change from the second wireless communicator 34b to the first wireless communicator 34a plus the time (T3) required to receive the print data through the first wireless communicator 34a (step S2838). This is an example of a comparator according to the invention.

Based on this comparison, the wireless communication device 30 (first controller 32) determines if T1<T2+T3 (step S2840). Note that the time (T2) required to change from the second wireless communicator 34b to the first wireless communicator 34a is stored in ROM 32c as a predetermined constant, and the value read from ROM 32c is used.

If the wireless communication device 30 (first controller 32) determines that T1<T2+T3 (step S2840: Yes), the wireless communication device 30 determines to use BLE communication as the wireless communication method (that is, the optimal handover destination) for receiving the specific data being communicated (print data in this example) (step S2842).

However, if T1<T2+T3 is not true (step S2840: No), the wireless communication device 30 (first controller 32) determines to use Wi-Fi communication (communication by Wi-Fi or the internal AP) as the wireless communication method (that is, the optimal handover destination) for receiving the specific data being communicated (print data in this example) (step S2844).

This embodiment of the invention provides a wireless communication device capable of determining the optimal handover destination based on data related to the data to be communicated (specifically, based on the result of the comparison in step S2838).

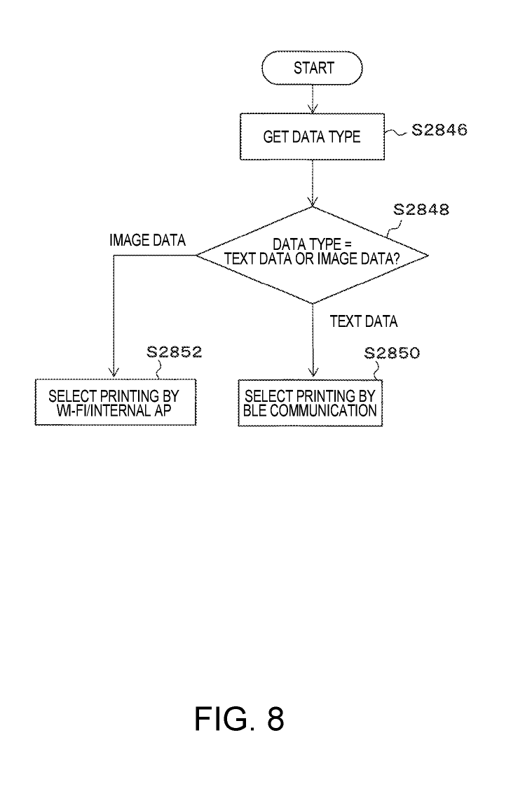

A fourth variation of the handover destination determination process is described next with reference to FIG. 8.

FIG. 8 is a flow chart of a handover destination determination process according to this fourth variation of the foregoing embodiment.

The handover destination determination process shown in FIG. 8 is a process of the wireless communication device 30 (first controller 32), based on data related to the data received by the second wireless communicator 34b (in this example, the data type of the print data), determining whether to use Wi-Fi communication or BLE communication as the wireless communication method (that is, the optimal handover destination) for receiving the specific data being communicated (in this example, print data). The handover destination determination process shown in FIG. 8 is executed in step S28 in FIG. 2 and FIG. 3.

First, the wireless communication device 30 (second wireless communicator 34b) acquires the data type of the print data from the wireless communication terminal 20 through the fourth wireless communicator 24b (step S2846).

Next, the wireless communication device 30 (first controller 32) determines if the data type acquired in step S2846 is text data or image data (step S2848).

If the data type is text data (step S2848: text data), the wireless communication device 30 (first controller 32) determines using BLE communication as the wireless communication method (that is, the optimal handover destination) for receiving the specific data being communicated (print data in this example) (step S2850).

However, if the data type is image data (step S2848: image data), the wireless communication device 30 (first controller 32) determines to use Wi-Fi communication (communication by Wi-Fi or the internal AP) as the wireless communication method (that is, the optimal handover destination) for receiving the specific data being communicated (print data in this example) (step S2852).

This embodiment of the invention provides a wireless communication device capable of determining the optimal handover destination based on data related to the data to be communicated (specifically, the data type of print data).

The foregoing embodiments and variations thereof describe the wireless communication device 30 executing the handover destination determination process, but the invention is not so limited. For example, the wireless communication terminal 20 may execute the handover destination determination process.

This is possible by, for example, the wireless communication terminal 20 (second controller 22) determining whether to use Wi-Fi communication or BLE communication as the wireless communication method for receiving the specific data being communicated (in this example, print data) based on data related to the data transmitted by fourth wireless communicator 24b (such as the data size of the print data and the number of pages). This is the same as the process described in FIG. 4. The selected method of wireless communication is then sent to the wireless communication device 30. These steps may be executed, for example, between steps S26 and S40 in FIG. 3.

This variation has the same effect as the embodiments and variations described above.

The foregoing embodiments use Wi-Fi communication as the first wireless communication method, and BLE communication as the second wireless communication method, but the invention is not so limited. More particularly, a wireless communication method other than Wi-Fi communication may be used as the first wireless communication method, and a wireless communication method other than BLE communication may be used as the second wireless communication method.

Values used in the foregoing embodiments are also used only for example, and different values can obviously be used as appropriate.

The foregoing embodiment is in all aspects only an example. The invention should not be understood as being limited by the foregoing description. The invention can be embodied in many other ways without departing from the spirit or main features described above.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A wireless communication device comprising:
a first wireless communication interface configured to communicate by a first wireless communication method;
a second wireless communication interface configured to communicate by a second wireless communication method having a slower communication speed than the first wireless communication method; and
a first processor configured to control the first wireless communication interface and second wireless communication interface;
the second wireless communication interface receiving data related to the communicated object from a corresponding wireless communication terminal; and
the first processor, based on data related to the communication object received through the second wireless communication interface, determining whether to use the first wireless communication method or the second wireless communication method as the wireless communication method to receive the specific data that is the communicated object.

2. The wireless communication device described in claim 1, wherein:
the data related to the communicated object indicates the data size of the specific data.

3. The wireless communication device described in claim 2, wherein:
the first processor calculates, from the data size of the specific data, the communication time required for communication, and based on the calculated communication time, determines whether to use the first wireless communication method or the second wireless communication method as the wireless communication method to receive the specific data of the communicated object.

4. The wireless communication device described in claim 1, further comprising:
a comparator configured to compare the time required to receive the specific data by the second wireless communication interface, and the sum of the time required to change from the second wireless communication interface to the first wireless communication interface plus the time required to receive the specific data by the first wireless communication interface;
the first processor determining, based on the result from the comparator, whether to use the first wireless communication method or the second wireless communication method as the wireless communication method to receive the specific data of the communicated object.

5. The wireless communication device described in claim 1, wherein:
the data related to the communicated object indicates the data type of the specific data.

6. The wireless communication device described in claim 1, wherein:
when the first processor selects the first wireless communication method to receive the specific data, the second wireless communication interface sends to the corresponding wireless communication terminal, by the second wireless communication method, connection information for connecting to an access point by the first wireless communication method.

7. The wireless communication device described in claim 1, wherein:
the second wireless communication method is communication by the BlueTooth Low Energy standard.

8. The wireless communication device described in claim 1, wherein:
the specific data is print data.

9. A wireless communication terminal that communicates with a wireless communication device, and comprises:
a third wireless communication interface configured to communicate by a first wireless communication method;
a fourth wireless communication interface configured to communicate by a second wireless communication method having a slower communication speed than the first wireless communication method; and
a second processor configured to control the third wireless communication interface and fourth wireless communication interface;
the second processor, based on data related to a communication object transmitted by the fourth wireless communication interface, determining whether to use the first wireless communication method or the second wireless communication method to send the specific data that is the communicated object.

10. A computer-readable non-transitory recording medium storing a program causing a wireless communication terminal that communicates with a wireless communication device and has a third wireless communication interface configured to communicate by a first wireless communication method, a fourth wireless communication interface configured to communicate by a second wireless communication method having a slower communication speed than the first wireless communication method, and a second processor configured to control the third wireless communication interface and fourth wireless communication interface, to function as:
a wireless communication decision unit that, based on data related to a communication object transmitted by the fourth wireless communication interface, determines whether to use the first wireless communication method or the second wireless communication method to send the specific data that is the communicated object.
